(19) United States
(12) Patent Application Publication
(10) Pub. No.: US 2004/0046600 A1
(43) Pub. Date: Mar. 11, 2004

(54) Equivalent circuit of voltage-controlled variable capacitive element

(76) Inventors: Yuki Fujimoto, Kanagawa (JP); Susumu Kurosawa, Kanagawa (JP)

Correspondence Address: MCGINN & GIBB, PLLC, 8321 OLD COURTHOUSE ROAD, SUITE 200, VIENNA, VA, 22182-3817, US

(21) Appl. No.: 10/647,463

(22) Filed: Aug. 26, 2003

(30) Foreign Application Priority Data
Aug. 27, 2002 (JP) 2002-247870

(51) Int. Cl. G05F 1/00

(52) U.S. Cl. 327/518

(57) ABSTRACT

The equivalent circuit is constructed such that a gate terminal is connected to a gate electrode of a P-channel MOS transistor as a varactor and a fixed capacitor is connected between a substrate terminal having a substrate potential and the gate terminal. In addition, source and drain of the P-channel MOS transistor are commonly connected to a source/drain terminal to have the same potential and a first voltage source is connected between the source/drain terminal and the substrate terminal so that the substrate terminal is connected to the positive terminal of the first voltage source. Accordingly, employment of the equivalent circuit of the present invention allows the simulation of the C-V characteristic curve of a voltage-controlled variable capacitive element as an actual device with extremely high accuracy.

### BACKGROUND OF THE INVENTION

1. Field of the Invention

The present invention relates to an equivalent circuit used to simulate a voltage-controlled variable capacitive element whose capacitance value is varied by an external voltage applied to the element to set a resonance frequency of a voltage-controlled oscillator (VCO) or the like to a desired value.

2. Description of the Related Art

FIG. 1 is a cross sectional view of a variable capacitive element consisting of a typical MOS varactor in an accumulation mode. For example, an N-well 560 is formed in a device formation region separated from other device formation regions by a field isolation film and provided in a surface portion of a P-type substrate 550, and a polysilicon gate electrode 570 is formed on a surface of the device formation region so that the gate electrode 570 and the surface of the device formation region interpose a gate oxide film 580 therebetween. Furthermore, a pair of N⁺ diffusion layers 582 are formed in surface portions of the N-well on both sides of the gate electrode 570. Thus, a MOS capacitor is formed between the gate electrode 570 and the N-well 560, between which the gate oxide film 580 is interposed, and a variable capacitive element is formed to have the gate electrode 570 and the N⁺ diffusion layers 582 as connection nodes Note that when a typical P-channel MOS transistor is employed as a capacitive element, a pair of diffusion layers to be formed in a surface portion of the N-well 560 are P⁺ diffusion layers.

FIG. 2 is a graphic diagram illustrating a high frequency Capacitance-Voltage (C-V) characteristic curve of a MOS varactor, shown in FIG. 1, in an accumulation mode, in which axis of abscissas denotes a gate to substrate voltage, and axis of ordinate denotes a gate to substrate capacitance value. The high frequency C-v characteristic curve of the MOS varactor in an accumulation mode varies such that when the capacitive element has a negative gate to substrate voltage applied thereto, a depletion zone in a surface portion of the N-well 560 spreads toward the side of the substrate 550 and therefore, the gate to substrate capacitance comes to have the capacitance value of a capacitor constructed by connecting in series the gate oxide film 580 and the depletion zone, resulting in gradual reduction in the gate to substrate capacitance value. Moreover, when further increasing the absolute value of a negative potential applied between the gate and the substrate, the distance over which the depletion zone spreads saturates and therefore, the gate to substrate capacitance also saturates at a minimum value. Conversely, when gradually changing the gate to substrate voltage from negative potential to positive potential, the depletion zone comes to have a shorter depth, resulting in gradual increase in the gate to substrate capacitance value. Moreover, when gradually increasing the absolute value of a positive potential applied between the gate and the substrate, an accumulation layer comes to be formed in a surface portion of the N-well 560 and the gate to substrate capacitance saturates to a capacitance value determined by the gate oxide film 580.

As described above, the variable capacitive element is constructed such that the gate to substrate capacitance value varies depending on the magnitude of a voltage applied between the gate electrode 570 and the N⁺ diffusion layers 582, and therefore, it can be employed as a capacitive element whose capacitance value is varied by an external voltage applied to the element to set a resonance frequency of a voltage-controlled oscillator to a desired value.

However, in the device design as to how the voltage-controlled variable capacitive element is to be shaped and sized, there is a limitation on our ability to evaluate performances of all possible types of capacitive elements that are previously fabricated on a substrate and accordingly, the conventional approach to evaluation of capacitive element is to prepare an equivalent circuit of a variable capacitive element and then evaluate shapes/dimensions and performance of the variable capacitive element through numerical computation that makes use of the equivalent circuit.

FIG. 3 illustrates a conventional equivalent circuit of a variable capacitive element and FIG. 4 illustrates a C-V characteristic curve of the equivalent circuit. The conventional equivalent circuit is constructed so that source and drain of a P-channel MOS transistor 300 are connected together to form a source/drain (SD) terminal 323 and have the same potential, and the SD terminal 323 is connected to a substrate terminal 325, and further, a gate to substrate capacitance is varied by changing a voltage, i. e., a gate to substrate voltage, applied between a gate electrode 321 and the substrate terminal 325.

In the conventional equivalent circuit incorporating therein a typical PMOS transistor as it is, when a voltage is applied to the gate electrode, a potential of substrate surface is changed, and then, in response to the change in the potential, a surface portion of the substrate changes from an accumulation state through a depletion state to an inversion state. Accordingly, when the gate to substrate voltage is set to a positive value and the surface portion of the substrate is in an accumulation or depletion state, i. e., the gate to substrate voltage is higher than a potential (threshold voltage) denoted by a broken line of FIG. 4, the capacitance of a capacitive element represented by the equivalent circuit changes depending on the gate to substrate potential.

However, when gradually changing the gate to substrate voltage to a potential lower than the threshold voltage, holes as a minority carrier are supplied from source/drain regions to initiate formation of inversion layer. Once an inversion layer is formed, the gate to substrate capacitance increases in proportion to decrease in the gate to substrate voltage. AS described above, in the case of the conventional equivalent circuit of a varactor in an accumulation mode, changing the gate to substrate voltage toward a potential negative with respect to the threshold voltage denoted by a broken line of FIG. 4 unfavorably increases the gate to substrate capacitance.

As can be seen from the C-V characteristic curve, shown in FIG. 4, of the conventional equivalent circuit, a relationship between a varactor capacitance and a bias voltage for controlling the varactor capacitance is unfavorably inverted at the boundary, i.e., the gate to substrate voltage denoted by the broken line 400 of FIG. 4. This inversion causes a serious problem particularly when the conventional model is applied to a varactor of a VCO (Voltage-Controlled Oscillator) in a PLL (Phase-Locked Loop) circuit. For example, when in order to minimize phase delay (increase frequency), the varactor capacitance is reduced by lowering the gate to substrate voltage (bias voltage) of the varactor, the lowering of the gate to substrate voltage normally reduces the gate to substrate capacitance, resulting in increase in frequency, as long as the gate to substrate voltage is greater than the potential denoted by the broken line 400.

However, when phase delay is further increased and then the bias voltage of the varactor is further lowered to minimize the phase delay, the bias voltage of the varactor transitions to a potential negative with respect to the potential denoted by the broken line 400, resulting in increase in the gate to substrate capacitance, which increase is proportional to decrease in the gate to substrate voltage. This unfavorably increases the phase delay. Then, the PLL circuit operates so that the bias voltage of the varactor is further lowered, resulting in further increase in the gate to substrate capacitance. Such operation is repeated and then the phase of the PLL cannot be controlled by the VCO.

Accordingly, a problem in applying the conventional model to the varactor can be described as follows. That is, the conventional model available for the voltage-controlled variable capacitive element (varactor) can be used only within a narrow bias range that includes potentials positive with respect to the potential denoted by the broken line 400.

### SUMMARY OF THE INVENTION

An object of the present invention is to provide an equivalent circuit for a voltage-controlled variable capacitive element that allows operation of a circuit incorporating therein a voltage-controlled variable capacitive element to be simulated together with the C-V characteristics of the capacitive element with extremely high accuracy and further allows significantly facilitated design of a circuit incorporating therein a voltage-controlled variable capacitive element.

The equivalent circuit for a voltage-controlled variable capacitive element according to the present invention includes: a MOS transistor having a source and a drain connected to each other; a first voltage source connected between a source/drain terminal of the MOS transistor and a substrate terminal; and a fixed capacitor connected between a gate electrode of the MOS transistor and the substrate terminal, in which the equivalent circuit is used to simulate characteristics of the voltage-controlled variable capacitive element by making use of how capacitance between a gate terminal used to provide electrical connection to the gate electrode of the MOS transistor and the substrate terminal varies.

The above-described equivalent circuit for a voltage-controlled variable capacitive element may further include a second voltage source connected between the gate terminal and the gate electrode.

The above-described equivalent circuit is further constructed such that the MOS transistor is a P-channel MOS transistor. The above-described equivalent circuit is further constructed such that the characteristics, to be simulated, of the voltage-controlled variable capacitive element are, for example, C-v characteristics of how gate to substrate capacitance C varies with gate to substrate voltage V.

In this case, a capacitance value of the fixed capacitor is adjusted so that values of the gate to substrate capacitance corresponding to the C-V characteristics are entirely increased. Additionally, a voltage value of the first voltage source is adjusted so that a gate to substrate voltage at which an inversion layer is created is shifted in a direction of negative voltage. Moreover, a voltage value of the second voltage source is adjusted so that values of the gate to substrate voltage corresponding to the C-V characteristics are entirely increased toward the side of positive potential. Still furthermore, operation of the equivalent circuit can be simulated using Bsim3 simulator.

### BRIEF DESCRIPTION OF THE DRAWINGS

FIG. 1 is a cross sectional view illustrating the configuration of a voltage-controlled variable capacitive element;

FIG. 2 is a graphic diagram illustrating C-v characteristics of the voltage-controlled variable capacitive element;

FIG. 3 is a circuit diagram illustrating a conventional equivalent circuit;

FIG. 4 is a graphic diagram illustrating C-V characteristics of the conventional equivalent circuit;

FIG. 5 is a circuit diagram illustrating an equivalent circuit for a voltage-controlled variable capacitive element according to a first embodiment of the invention;

FIG. 6 is a graphic diagram illustrating C-V characteristics of the equivalent circuit constructed in accordance with the first embodiment;

FIG. 7 is a flow chart diagram illustrating how the equivalent circuit constructed in accordance with the first embodiment operates;

FIG. 8 is a circuit diagram illustrating an equivalent circuit for a voltage-controlled variable capacitive element according to a second embodiment of the invention;

FIG. 9 is a graphic diagram illustrating comparison between a simulated C-V characteristic curve of the conventional equivalent circuit of each of FIGS. 3, 4 and a measured C-V curve corresponding to measurement data obtained by measurement of the actual device;

FIG. 10 is a circuit diagram illustrating an equivalent circuit configured to add an external fixed capacitor 140 to the conventional equivalent circuit;

FIG. 11 is a graphic diagram illustrating how addition of the external fixed capacitor 140 affects a C-V characteristic curve of the equivalent circuit;

FIG. 12 is a graphic diagram illustrating how a Bsim3 parameter VTH0 affects the simulated C-v characteristic curve of the equivalent circuit;

FIG. 13 is a graphic diagram illustrating how a Bsim3 parameter DLC affects the simulated C-V characteristic curve of the equivalent circuit;

FIG. 14 is a graphic diagram illustrating how a Bsim3 parameter DLC affects the simulated C-V characteristic curve of the equivalent circuit;

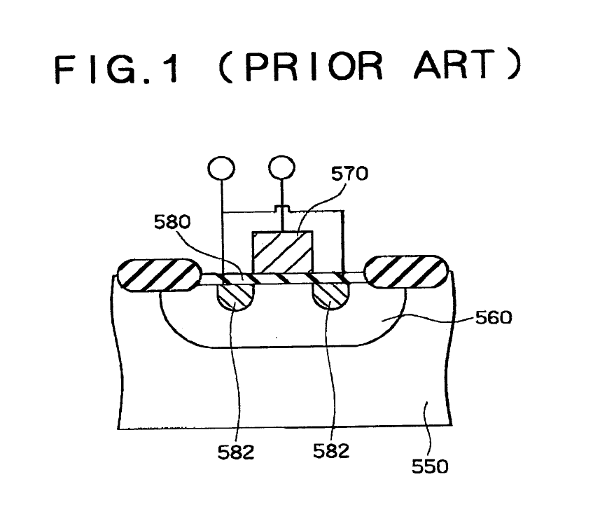

FIG. 1S is a graphic diagram illustrating how addition of the first voltage source 130 affects the C-V characteristic curve of the equivalent circuit;

FIG. 16 is a graphic diagram illustrating fitting accuracy achieved by employment of the equivalent circuit of the first embodiment;

FIG. 17 is a graphic diagram illustrating how the Bsim3 parameter VTH0 affects the C-V characteristic curve of the equivalent circuit;

FIG. 18 is a graphic diagram illustrating how addition of the second voltage source 150 affects the C-V characteristic curve of the equivalent circuit;

FIG. 19 is a graphic diagram illustrating fitting accuracy achieved by employment of the equivalent circuit of the second embodiment;

FIG. 20 is a circuit diagram illustrating an equivalent circuit of a voltage-controlled variable capacitive element according to a third embodiment of the invention; and

FIG. 21 is a circuit diagram illustrating an equivalent circuit of a voltage-controlled variable capacitive element according to a fourth embodiment of the invention.

### THE PREFERRED EMBODIMENTS OF THE INVENTION

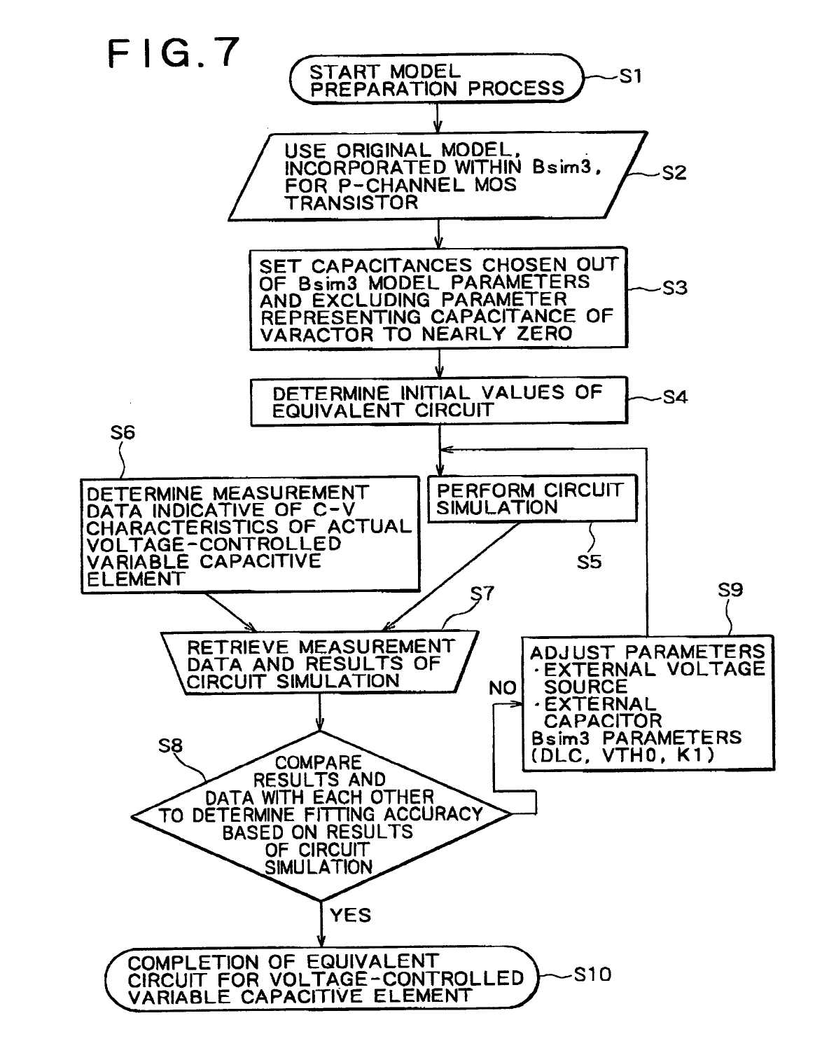

Preferred embodiments of the present invention will be explained in detail below with reference to the attached drawings. FIG. 5 is a circuit diagram illustrating an equivalent circuit of a voltage-controlled variable capacitive element according to a first embodiment of the invention. The equivalent circuit is constructed such that a gate terminal 121 is connected to a gate electrode 122 of a P-channel MOS transistor 110 representing a varactor and a fixed capacitor 140 is connected between a substrate terminal 125 having a substrate potential and the gate terminal 121 so that the fixed capacitor is connected in parallel with the P-channel MOS transistor 110 In addition, source and drain of the P-channel MOS transistor 110 are commonly connected to a source/drain terminal 123 to have the same potential and a first voltage source 130 is connected between the source/drain terminal 123 and the substrate terminal 125 so that the substrate terminal 125 is connected to a positive terminal of the first voltage source 130.

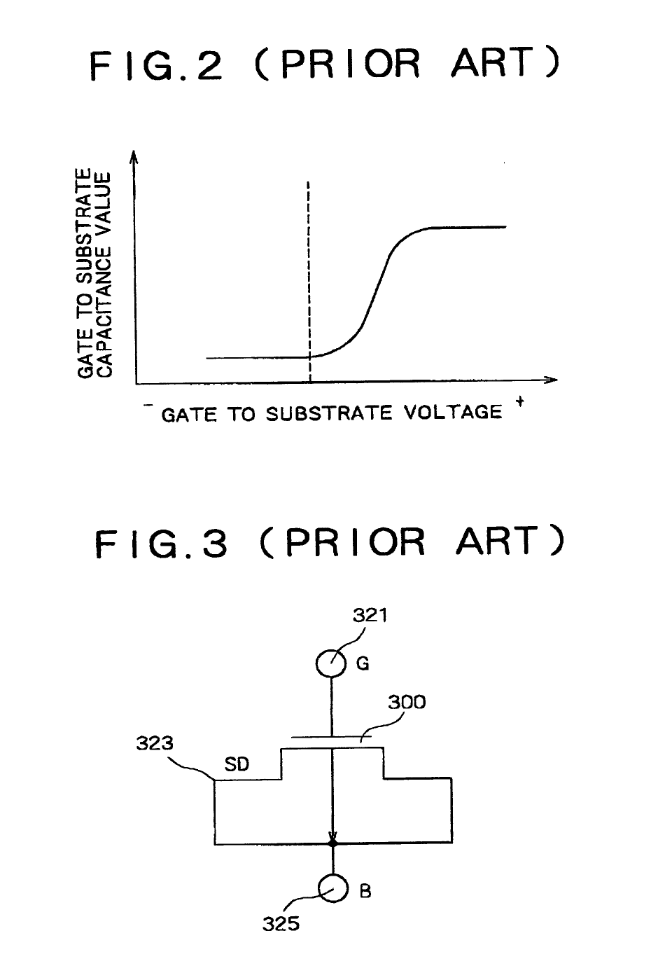

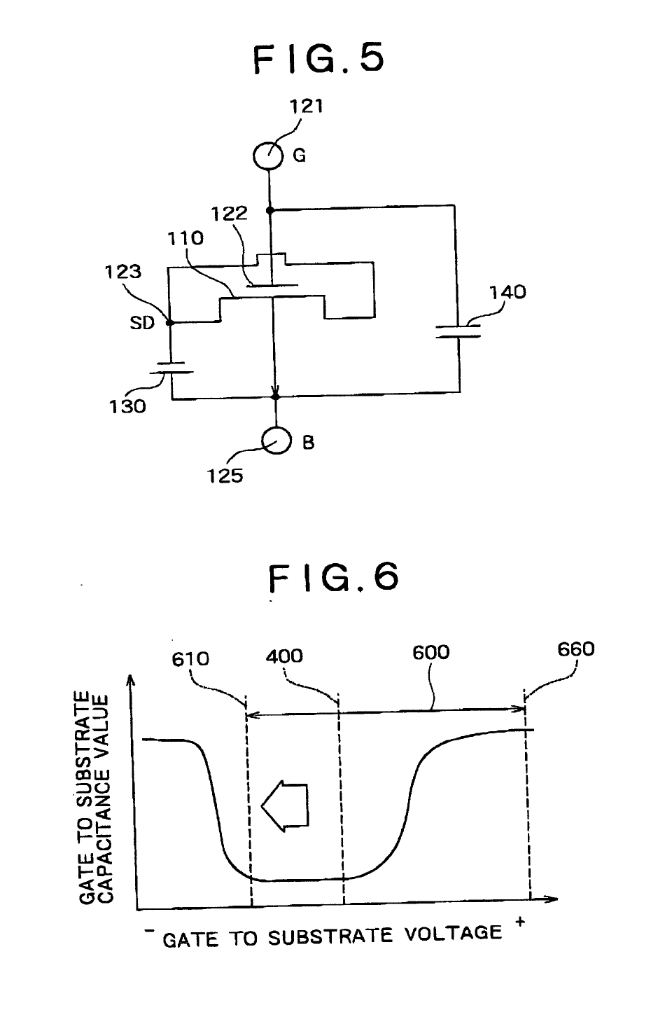

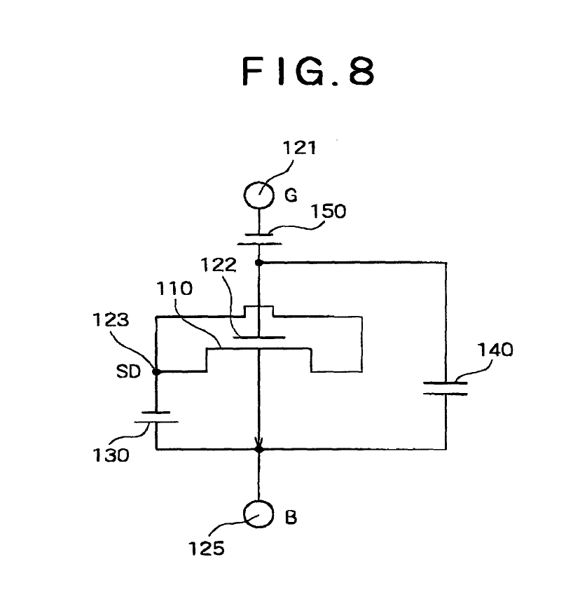

FIG. 6 illustrates a C-V characteristic curve of the equivalent circuit constructed as described above. In the graph of FIG. 6, the axis of abscissas indicates a gate to substrate voltage applied between the gate terminal 121 and the substrate terminal 125, and the axis of ordinate indicates a gate to substrate capacitance corresponding to the gate to substrate voltage being applied. In the invention, the first voltage source 130 is connected between the source/drain terminal 123 and the substrate terminal 125 so that the first voltage source 130 is connected in parallel with the P-channel MOS transistor 110, and therefore, a voltage at which an inversion layer is created is shifted in the direction (denoted by an outline arrow on a colored background of FIG. 6) of negative voltage. That is, as shown in FIG. 4, when employing the conventional model or equivalent circuit, the inversion layer is created at a gate to source voltage lower than the potential denoted by the broken line 400, resulting in increase in the gate to substrate capacitance. However, when employing the model or equivalent circuit according to the invention, the potential at which an inversion layer is created can be shifted to a negative potential denoted by a broken line 610 of FIG. 6. Accordingly, in a voltage range 600 defined by the broken line 610 and a broken line 660 of FIG. 6, a C-V characteristic curve shown in FIG. 6 becomes equivalent to the actual C-V characteristic curve, shown in FIG. 2, of the voltage-controlled variable capacitive element. Furthermore, the fixed capacitor 140 is provided to represent a parasitic capacitance associated with a transistor while representing a capacitance (fringing capacitance) as a plat portion of the C-V curve in the negative potential region, in which portion the gate to substrate capacitance becomes minimum.

In the present invention, the above-described equivalent circuit is employed as a model and using a circuit simulator, shapes and dimensions are determined for a voltage-controlled variable capacitive element that is capable of providing desired characteristics. Among such types of circuit simulator models, a model called “Bsim3 model” developed by the Department of Electrical Engineering and Computer Sciences at the University of California at Berkeley is known to those skilled in the art. Although the Bsim3 model is fundamentally a physical model, in terms of availability of a Bsim3 model as a circuit simulator and in view of reduction in calculation time and improvement in the nature of convergence, daring approximation algorithms are executed in many possible portions of the model and a number of fitting parameters are introduced into the model to compensate for degradation in accuracy resulting from approximation.

In this cases fitting of a threshold voltage shift of the P-channel MOS transistor 110 due to insertion of the first voltage source 130 into the position between the source/drain terminal 123 and the substrate terminal 125 is carried out using Bsim3 parameters representing a threshold voltage. In addition, by changing typical MOSFET model parameters, representing a source capacitance and drain capacitance, from the Bsim3 model to nearly zero, influence of capacitances other than a varactor capacitance is minimized. A fringing capacitance, etc. is represented by the fixed capacitor 140 connected in parallel with the P-channel MOS transistor 110 to allow fitting of the fringing capacitance, etc.

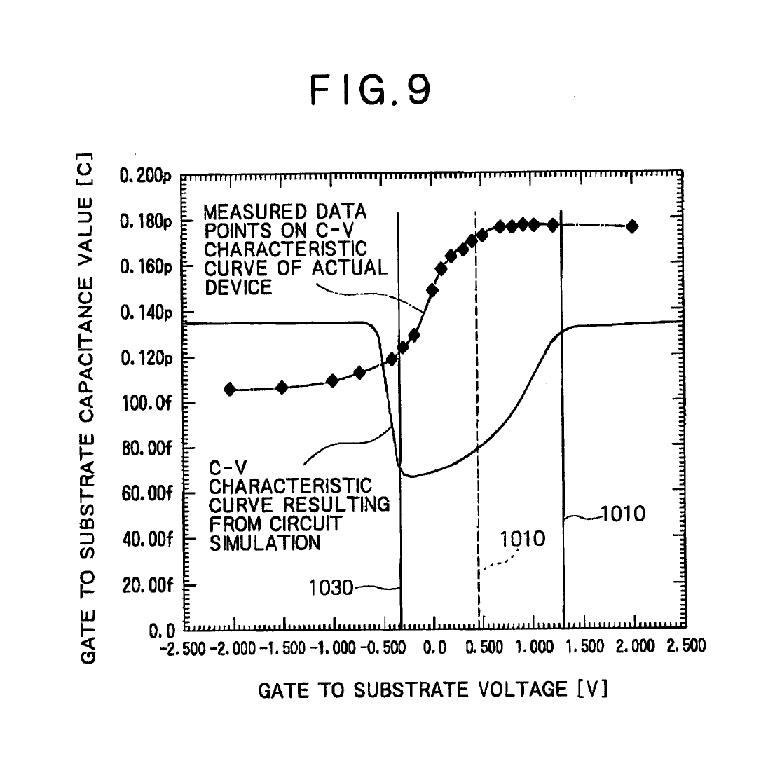

FIG. 7 is a flow chart diagram illustrating process steps of preparing an equivalent circuit of a MOS varactor through use of Bsim3 model. The steps includes: starting model preparation process (step S1); constructing individual components of the equivalent circuit shown in FIG. 5 through use of an original model, incorporated within Bsim3, for a P-channel MOS transistor (step S2); setting capacitances chosen out of Bsim3 model parameters and excluding the parameter representing the capacitance of varactor to nearly zero (step S3); determining the initial values of the equivalent circuit (step S4); and performing circuit simulation (step S5) to determine the C-V characteristic curve of the equivalent circuit shown in FIG. 5. Furthermore, the steps includes: determining measurement data indicative of the C-V characteristics of the actual voltage-controlled variable capacitive element shown in FIG. 1 (step S6); retrieving the measurement data and the results of circuit simulation (step S7); and comparing the results and the data with each other to determine fitting accuracy based on the results of circuit simulation (step S8). Still furthermore, the steps includes: adjusting a capacitance value of the fixed capacitor 140, a voltage value of the first voltage source 130 and the Bsim3 parameters when the fitting accuracy is low (No) (step S9); and performing again circuit simulation (step S5). Such comparison between the measurement data and the results of circuit simulation is repeated and when the fitting accuracy is determined sufficiently high (Yes), the parameters at this point make up a completed equivalent circuit of a MOS varactor (variable capacitive element) (step S10). Using the equivalent circuit of the voltage-controlled variable capacitive element prepared as described above, the voltage-controlled variable capacitive element having desired performance is designed.

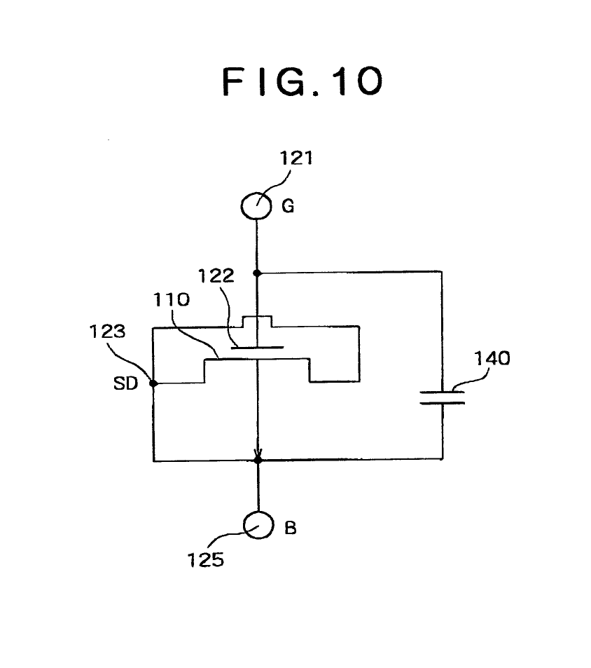

FIG. 8 is a circuit diagram illustrating an equivalent circuit of a voltage-controlled variable capacitive element according to a second embodiment of the invention. The difference between the first embodiment shown in FIG. 5 and the second embodiment is that the second embodiment is constructed so that a second voltage source 150 is connected between a gate terminal 121 and a gate electrode 122 of a P-channel MOS transistor 110, and has its positive terminal connected to the gate electrode 122.

In the equivalent circuit of the second embodiment, a threshold shift due to insertion of the first voltage source 130 into the position between a source/drain terminal 123 and a substrate terminal 125 can be more flexibly determined by connecting the second voltage source 150 in series between the gate terminal 121 and the gate electrode 122 and then adjusting a parameter representing the second voltage source 150 in addition to adjusting Bsim3 parameters representing a threshold voltage. That is, in the second embodiment, inserting the second voltage source 150 so that the voltage source 150 is connected in series to the gate of the transistor 110 makes it possible to adjust the threshold voltage of the P-channel MOS transistor 110 and flexibly determine the threshold voltage thereof through combination of the parameter representing the second voltage source 150 and the Bsim3 model parameter for the control of the threshold voltage thereof. As a result, an equivalent circuit whose C-V characteristic curve is more nearly fitted to the C-V characteristic curve of the actual variable capacitive element (varactor), in which an inversion layer is never created, can be obtained.

Subsequently, beneficial effects obtained by fitting the parameters that represent circuit components employed in the equivalent circuit to the measurement data will be explained. How the individual circuit components of the equivalent circuit shown in FIG. 5 or FIG. 8 advantageously affect the simulation of c-v characteristics is as follows. First, the external fixed capacitor (external capacitor) 140 serves to increase or decrease the overall capacitance value of the C-V characteristic curve. Furthermore, the first voltage source 130 serves to shift a voltage at which the inversion layer is created. Still furthermore, the second voltage source 150 serves to shift a position at which the C-v characteristic curve begin rising.

Additionally, how the Bsim3 model parameters advantageously affect the simulation of C-V characteristics is as follows. First, DLC serves to increase or decrease the range of amplitude over which the capacitance value of the variable capacitive element varies. Furthermore, VTH0 serves to shift a position at which the C-v characteristic curve begins rising and at the same time, adjust an angle, at which the C-V characteristic curve turns at the corner, by optimizing VTH0. Still furthermore, K1 serves to increase or decrease an angle at which the C-V characteristic curve begins rising and the range of amplitude over which the capacitance value varies.

It should be noted that the components and the model parameters depend on each other. Accordingly, the above-noted explanation was made of where the C-V characteristic curve obtained as a result of the simulation appears changed to the maximum when changing the individual values of the components and the model parameters, and the individual components and the C-V characteristic curve do not have one-to-one relationship.

Making use of the above-described features of individual parameters, fitting is carried out. Fitting is carried out as follows. That is, a C-V characteristic curve is obtained by measuring the actual variable capacitive element in a high frequency range and the results of simulation of an equivalent circuit are fitted within a range of required accuracy to the data corresponding to the C-v characteristic curve by adjusting the values of individual components of an equivalent circuit. How to fit the results of simulation of an equivalent circuit to the data points on the C-V characteristic curve will be explained in detail below.

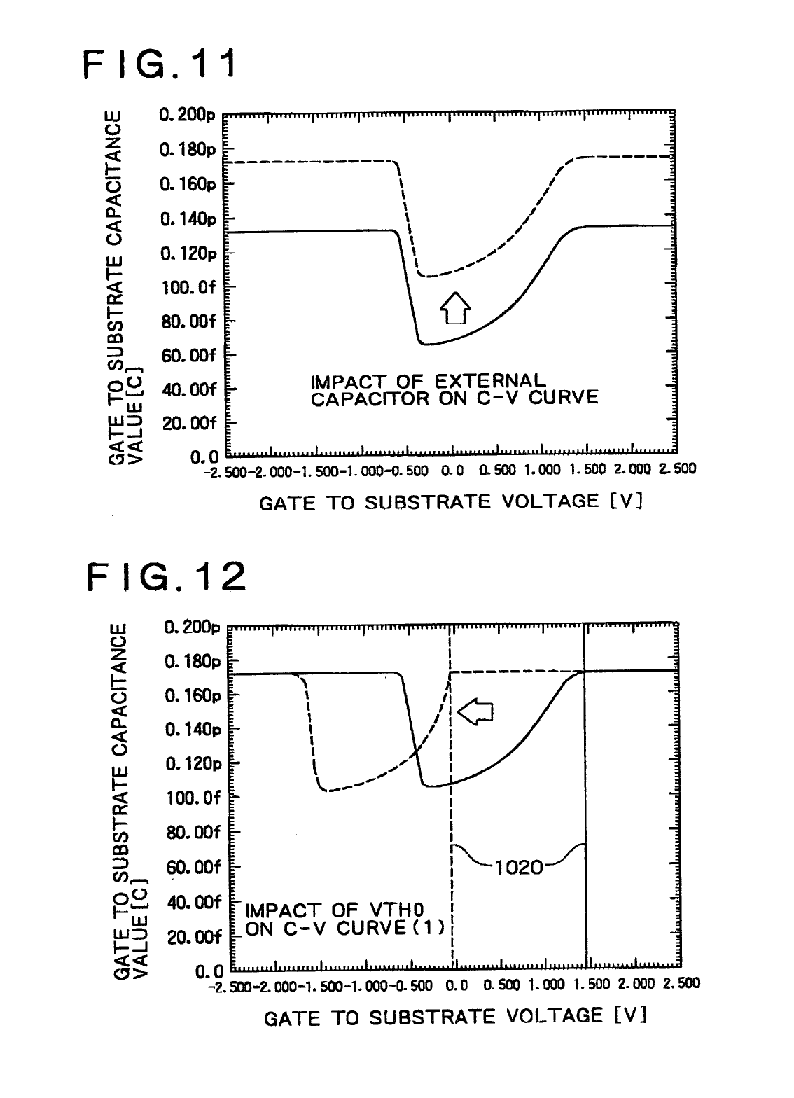

First, a typical C-V characteristic curve of a P-channel MOS transistor is shown in FIG. 9. FIG. 9 is a graphic diagram illustrating comparison between a C-V characteristic curve (denoted by a solid line) of the conventional equivalent circuit of a typical P-channel MOS transistor (L=0.16 micrometers, W=100 micrometers) and measured data points on a C-V characteristic curve (denoted by a dashed line and black rectangular dots) of the actual voltage-controlled variable capacitive element. As described above, the C-v characteristic curve of the P-channel MOS transistor increases in gate to substrate capacitance value (capacitance value) at an inversion layer creation voltage (denoted by a line 1030 and being equal to about −0.3V) in the negative potential region, which increase is due to creation of inversion layer. Furthermore, a potential (denoted by a line 1010) at which the C-V characteristic curve begins rising is located in a position in the positive potential region, which position is largely apart from the zero potential point, and further, the overall capacitance is small.

Subsequently, parameters chosen out of the Bsim3 model parameters and representing capacitances are set to nearly zero (0). Parameters chosen out of the Bsim3 model parameters and representing capacitances other than the capacitance of varactor are, for example, CGSO (gate to source parasitic capacitance), CGDO (gate to drain parasitic capacitance), CJ (bottom junction per unit area), CJSW (capacitance of sidewalls of PN junctions within a substrate when an applied bias to the junctions is 0V), etc. Those parameters are made small so as not to materially affect the circuit simulation. This is because if all of the Bsim3 model parameters (particularly, Bsim3 model parameters representing capacitances) are used as they are to perform circuit simulation, unexpected phenomenon due to a difference between structures of a MOS-type variable capacitive element and a P-channel MOS transistor occurs and such unexpected phenomenon has to be avoided. Note that as is already described, the difference is that in case of variable capacitive element, source/drain diffusion layers of variable capacitive element formed in an N-well in a surface portion of a substrate are of N⁺ conduction type and the N-well and the source/drain diffusion layers are formed to have the same potential, and conversely, in case of P-channel MOS transistor, source/drain diffusion layers of P-channel MOS transistor formed in an N-well in a surface portion of a substrate are of P⁺ conduction type.

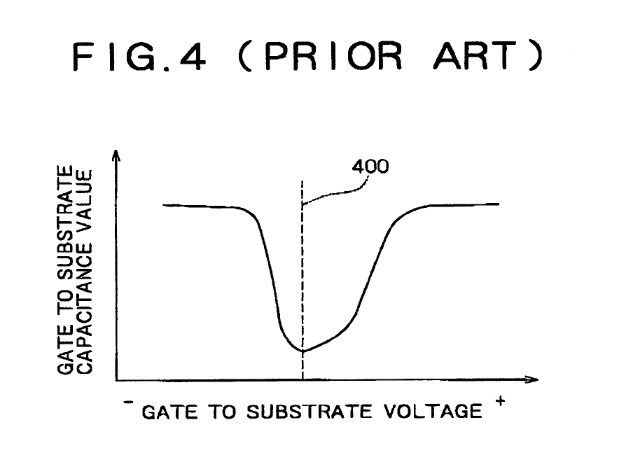

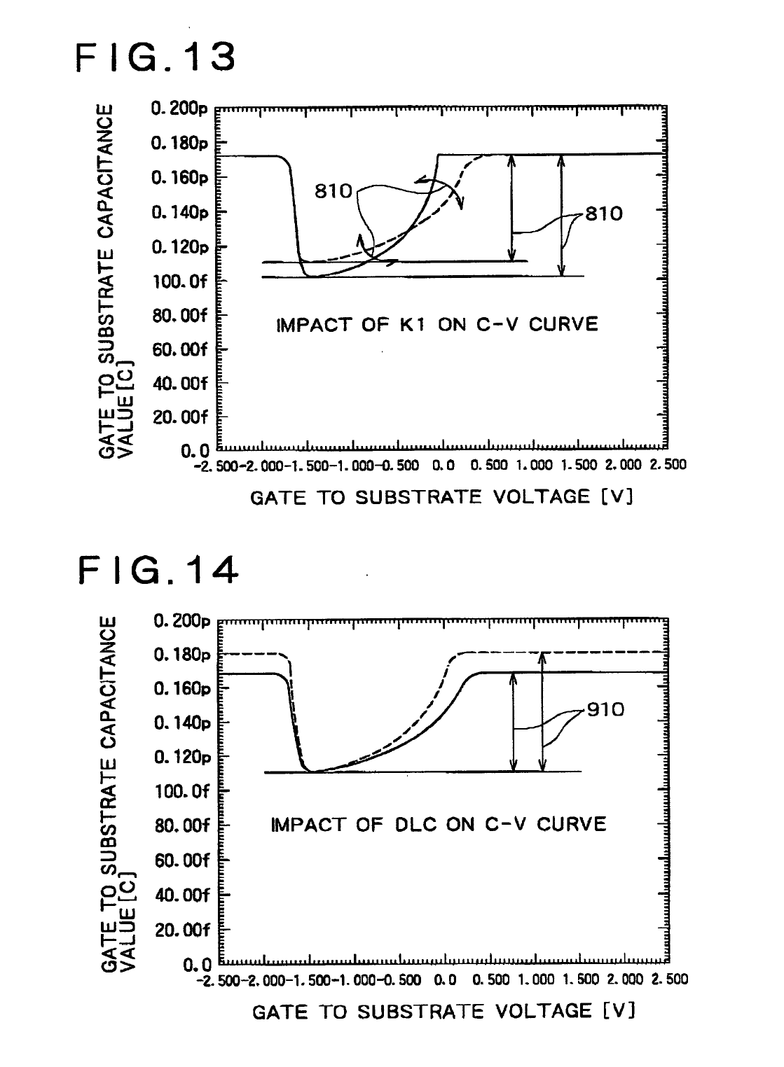

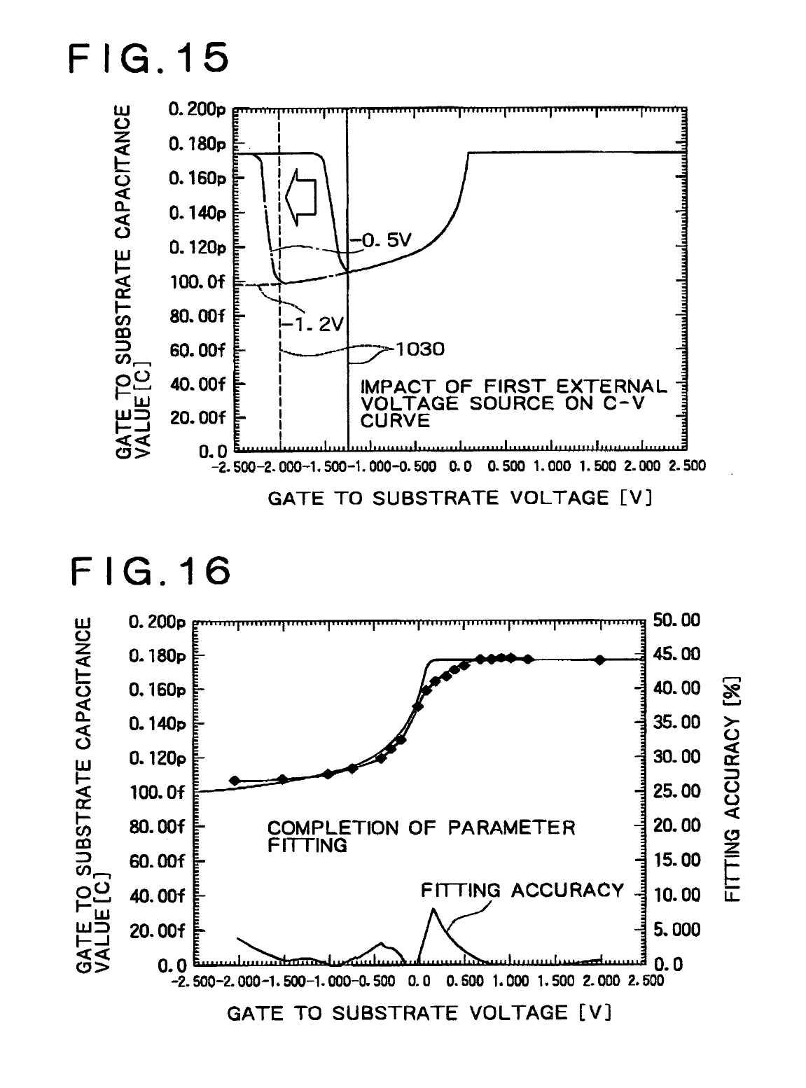

Subsequently, explanation will be made of results that are obtained from circuit simulation when the external fixed capacitor 140 is added to the conventional equivalent circuit (representing only a P-channel transistor 300 shown in FIG. 3) with reference to FIG. 10. It should be understood that in FIG. 10, like numerals refer to like parts of FIG. 5. FIG. 11 is an illustration of a simulated C-v characteristic curve of the equivalent circuit shown in FIG. 10. In FIG. 11, a solid line indicates results obtained from circuit simulation when the external capacitor 140 is not added to the transistor and a broken line indicates results obtained from circuit simulation when the external capacitor 140 having a capacitance value of 0.07 pF is added to the transistor. Note that in the Bsim3 model employed in the embodiment, parameters chosen out of the Bsim3 model parameters and representing capacitances other than the capacitance of varactor are set to nearly zero.

As can be seen from FIG. 11, adding the external capacitor 140 to the transistor increases a gate to substrate capacitance value as a whole (i.e., over the entire gate to substrate voltages).

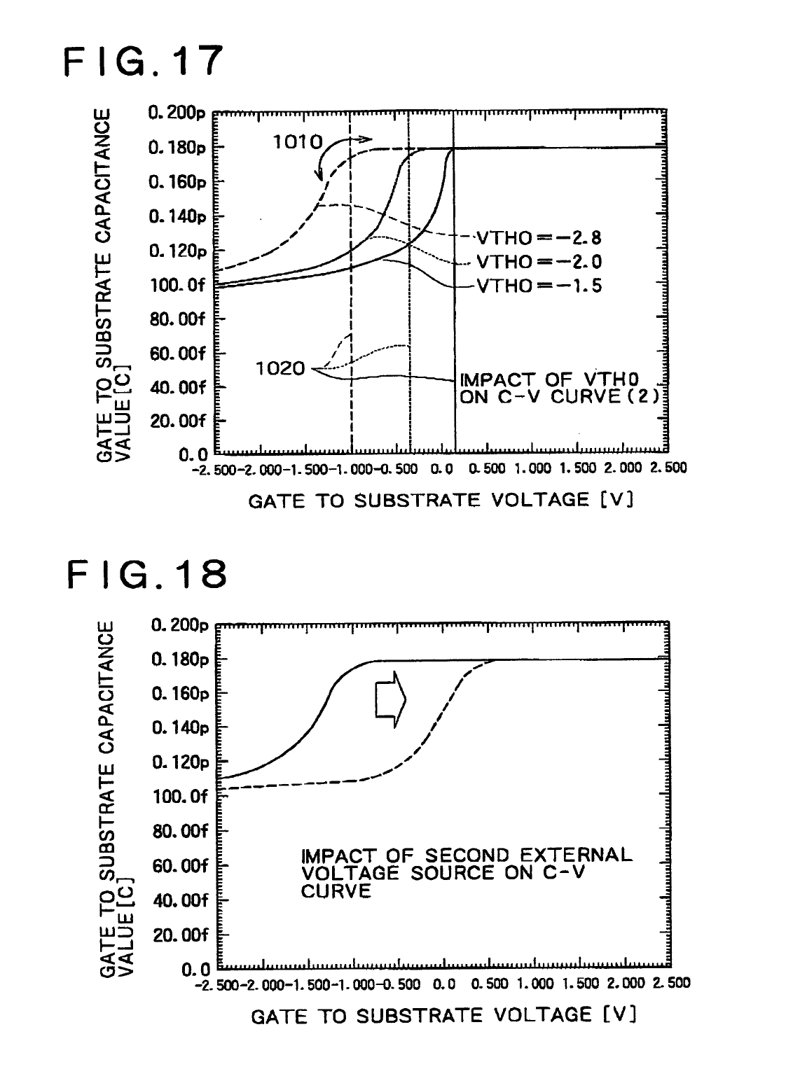

Subsequently, explanation will be made of results obtained from the circuit simulation performed by adjusting the Bsim3 model parameters. VTH0 employed in Bsim3 is a parameter used to adjust a threshold voltage. As shown in FIG. 12, when VTH0 is set to a negative value, a gate to substrate voltage (denoted by a line 1020) at which the capacitance begins falling shifts in the direction of negative voltage. In the figure, a broken line indicates a C-V curve obtained when VTH0 is set to about −1.5 volts.

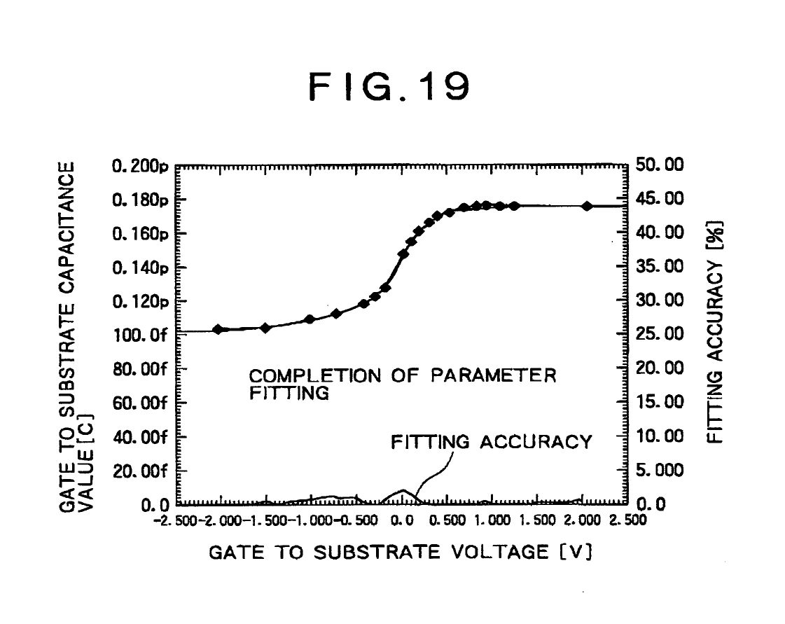

K1 is first order body effect coefficient. As shown in FIG. 13, when increasing the value of K1, a gradient 800 of the C-V characteristic curve is reduced (in other words, the extent to which the curve is pulled down is reduced) and the range of amplitude 810 representing the degree to which the capacitance is reduced from its maximum value to its minimum value is reduced as indicated by a broken line of the figure. In the figure, a broken line indicates a C-V curve obtained when K1 is set to about 1.1.

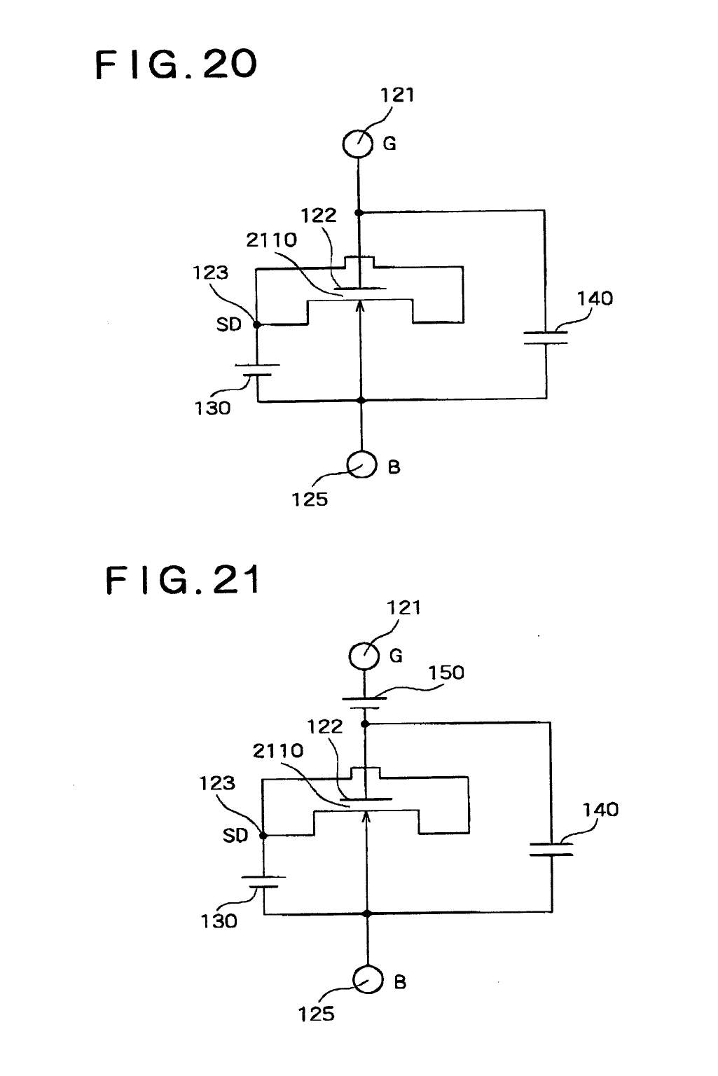

DLC is a gate length offset fitting parameter from C-V characteristics. As shown in FIG. 14, when decreasing the value of DLC, the range of amplitude 910 representing the degree to which the capacitance indicated by a C-V characteristic curve is increased from its minimum value to its maximum value is increased as indicated by a broken line of the figure. In the figure, the broken line indicates a C-V curve obtained when DLC is set to about 2.0×10⁻⁸.

Subsequently, explanation will be made of how addition of the first voltage source 130 advantageously affects circuit simulation. When adding the external first voltage source 130 to the equivalent circuit of FIG. 10, as shown in FIG. 5, a C-v characteristic curve determined by the circuit simulation results as shown in FIG. 15. In FIG. 15, a solid line (being the same as the broken line of FIG. 11) indicates a C-V characteristic curve determined by circuit simulation when the first voltage source 130 is not added to the equivalent circuit and a dashed line and a broken line indicate a C-V characteristic curve determined by circuit simulation when the first voltage source 130 is added to the equivalent circuit. Note that the dashed line indicates results of circuit simulation performed when the first voltage source 130 supplies −0.5 V and the broken line indicates results of circuit simulation performed when the first voltage source 130 supplies −1.2 V. As can be seen from FIG. 15, adding the first voltage source 130 to the equivalent circuit makes it possible to shift the inversion layer creation voltage (denoted by a line 1030) in the direction of negative voltage to a level (in this case, not greater than −1.5 V) beyond a voltage range over which the varactor can be controlled.

Thereafter, the steps are performed including (1) setting parameters representing capacitances to nearly zero; (2) adding the external capacitor 140; (3) adjusting the Bsim3 model parameters; and the steps (1) to (3) are repeated while the associated parameters are adjusted (this operation is referred to as parameter fitting) until a difference between the measurement data and the results of circuit simulation comes to meet a range of required accuracy (for example, a range from −10% to +10%).

FIG. 16 is an illustration of C-V characteristic curve resulted upon completion of parameter fitting, in which the axis of abscissas indicates a gate to substrate voltage and the axis of ordinate indicates a gate to substrate capacitance. In the figure, black rectangular dots represent measurement data that is obtained by measurement of the actual variable capacitive element and corresponds to a C-V characteristic curve, and a solid line indicates a C-V characteristic curve of the equivalent circuit (shown in FIG. 5) whose parameters are determined by circuit simulation. Furthermore, fitting accuracy achieved by the above-described parameter fitting is also shown in the figure. As can be seen from FIG. 16, the actual measurement data and the results of circuit simulation precisely coincide with each other, verifying the equivalent circuit according to the first embodiment of the invention allows the model parameters used during circuit simulation to be fitted to the actual measurement data with high accuracy (error is small).

FIG. 17 is a graphic diagram illustrating how the C-V characteristic curve is affected by a Bsim3 parameter VTH0. Furthermore, when the Bsim3 parameter VTH0 is set to a negative value and the absolute value of VTH0 is increased, a position 1020 at which the gate to substrate capacitance begins falling gradually shifts to the side of negative potential and at the same time, an angle at which the C-V characteristic curve turns at a corner 1010 is gradually reduced. As shown in FIG. 16, the results of simulation of the equivalent circuit shown in FIG. 5 teach that the corner of the simulated C-V characteristic curve has a radius of curvature that is smaller than the radius of curvature of the corner of the measured C-V curve corresponding to the actual measurement data and further has a gradient greater than that of the corner of the measured C-V curve corresponding to the actual measurement data, and fitting accuracy at the corner of the simulated C-V characteristic curve is relatively low. To address this problem, the value of VTH0 is set negative to enlarge the radius of curvature of the corner of the simulated C-V characteristic curve and reduce the gradient of the corner 1010 of the simulated C-v curve. However, as described above, setting the value of VTH0 negative unfavorably shifts the position 1020 at which the capacitance begins falling to the side of negative potential.

To address this problem, the second voltage source 150 is provided as shown in the equivalent circuit of the second embodiment shown in FIG. 8. FIG. 18 illustrates a C-V characteristic curve (broken line) resulting from circuit simulation performed when the second voltage source 150 supplies a voltage of about +1.6 volts, and further, shows for comparison a C-V curve (solid line) resulting from circuit simulation performed when the second voltage source 150 is not provided. As shown in FIG. 18, providing the second voltage source 150 advantageously shifts a position at which the C-V curve begins falling to the side of positive potential and cancels a voltage shift toward the side of negative potential, which voltage shift is caused by adjusting VTH0 and determined by a voltage difference between positions at which the C-V curves begin falling. Accordingly, providing the second voltage source 150 makes it possible to maintain as it is the profile of a C-V characteristic curve and further shift the entire profile of the C-V characteristic curve to the side of positive potential.

It should be noted that although parameters K1 and DLC chosen out of Bsim3 model parameters and excluding VTH0 also serve to adjust change in the range of amplitude over which a C-V characteristic curve varies and capacitance value of the C-V curve, those parameters, as is the case with VTH0, also serve to change the position 1020 at which the C-V curve begins falling. Also in this case, providing the second voltage source 150 makes it possible to cancel a voltage shift caused by adjustment of those parameters K1, DLC and determined by a voltage difference between positions 1020 at which the C-V curves begin falling, allowing fitting operation to flexibly and easily be performed.

FIG. 19 is a graphic diagram illustrating fitting accuracy achieved by the above-described fitting performed using the equivalent circuit, shown in FIG. 8, of the second embodiment. As can be seen from FIG. 19, a C-V characteristic curve (denoted by black rectangular dots) of the actual variable capacitive element and a C-V characteristic curve resulting from simulation of the equivalent circuit highly precisely coincide with each other, verifying the equivalent circuit according to the second embodiment allows the model parameters used during the simulation to be fitted to the actual measurement data with extremely high accuracy (error is extremely small).

As described above, the equivalent circuit according to the present invention produces many beneficial effects. That is, the first voltage source 130 is connected between the source/drain terminal 123 and the substrate terminal 125 so that the first voltage source 130 is connected in parallel with the P-channel MOS transistor 110 and therefore, as shown in FIG. 6, a bias voltage at which an inversion layer is created can be moved in the direction of negative voltage from the control voltage range 600, over which a voltage-controlled variable capacitive element (varactor) is controlled, to the outside 610 of the control voltage range 600. Additionally, parameters chosen out of Bsim3 model parameters and representing source capacitance and drain capacitance are set to nearly zero to prevent source capacitance and drain capacitance used in a typical MOS transistor model from affecting circuit simulation performed using Bsim3 model and further, the fringing capacitance, etc. is represented by the fixed capacitor 140 connected in parallel between the gate and the substrate to allow fitting of the fringing capacitance, etc. Moreover, the first voltage source 130 is provided to allow change in the threshold voltage of P-channel MOS transistor to be adjusted using parameters chosen out of Bsim3 model parameters and used to control a threshold voltage.

Furthermore, inserting the second voltage source 150 so that the second voltage source 150 is connected in series to the gate of the transistor allows the threshold voltage of P-channel MOS transistor to be adjusted and combining the second voltage source 150 with parameters chosen out of Bsim3 model parameters and used to control a threshold voltage allows flexible fitting.

It should be understood to those skilled in the art that in the equivalent circuit of the present invention, the MOS transistor 110 is not limited to a P-channel MOS transistor, but may be an N-channel MOS transistor and an appropriate MOS transistor can be employed depending on a variable capacitive element to be simulated. FIG. 20 is a circuit diagram illustrating an embodiment that employs an N-channel MOS transistor 2110 instead of the P-channel MOS transistor 110 employed in the embodiment shown in FIG. 5. In the equivalent circuit, the polarity of a first voltage source 130 is inverted. The embodiment also produces beneficial effects similar to those by employment of the embodiment shown in FIG. 5.

FIG. 21 is a circuit diagram illustrating an embodiment that employs an N-channel MOS transistor 2110 instead of the P-channel MOS transistor 110 employed in the embodiment shown in FIG. 8. In the equivalent circuit, the polarities of a first voltage source 130 and a second voltage source 150 are inverted. The embodiment also produces beneficial effects similar to those by employment of the embodiment shown in FIG. 8.

As described in detail so far, in the conventional equivalent circuit, when a gate to substrate voltage changes to the side of negative potential beyond a threshold voltage, an inversion layer is created and then increase in a gate to substrate capacitance value occurs, as indicated by the C-V characteristic curve shown in FIG. 4. In contrast, in the equivalent circuit constructed in accordance with the present invention, a bias voltage at which an inversion layer is created can be shifted in the direction of negative potential from the control voltage range, over which the voltage-controlled variable capacitive element (varactor) is controlled, to the outside (in more detail, to the voltage lower relative to the outside) of the control voltage range, as shown in FIG. 6. As a result, an ideal C-V characteristic curve can be obtained that is equivalent to the C-V characteristic curve of the actual voltage-controlled variable capacitive element. Accordingly, employment of the equivalent circuit of the present invention allows the simulation of a circuit operation characteristics with the C-V characteristic curve of a voltage-controlled variable capacitive element as an actual device with extremely high accuracy. Consequently, the present invention is able to largely contribute to designing in a short period of time a circuit that incorporates therein a voltage-controlled variable capacitive element and further, reducing the cost of manufacturing the circuit.

What is claimed is:

1. An equivalent circuit for a voltage-controlled variable capacitive element, comprising:
a MOS transistor having a source and a drain connected to each other;
a first voltage source connected between a source/drain terminal of said MOS transistor and a substrate terminal; and
a fixed capacitor connected between a gate electrode of said MOS transistor and said substrate terminal,
said equivalent circuit being used to simulate characteristics of said voltage-controlled variable capacitive element by a characteristics of capacitance between a gate terminal connected to said gate electrode of said MOS transistor and said substrate terminal.

2. The equivalent circuit for a voltage-controlled variable capacitive element according to claim 1, further comprising a second voltage source connected between said gate terminal and said gate electrode.

3. The equivalent circuit for a voltage-controlled variable capacitive element according to claim 1, wherein said MOS transistor is a P-channel MOS transistor.

4. The equivalent circuit for a voltage-controlled variable capacitive element according to claim 2, wherein said MOS transistor is a P-channel MOS transistor.

5. The equivalent circuit for a voltage-controlled variable capacitive element according to claim 1, wherein said characteristics, to be simulated, of said voltage-controlled variable capacitive element are C-V characteristics of how gate to substrate capacitance C varies with gate to substrate voltage V.

6. The equivalent circuit for a voltage-controlled variable capacitive element according to claim 2, wherein said characteristics, to be simulated, of said voltage-controlled variable capacitive element are C-V characteristics of how gate to substrate capacitance C varies with gate to substrate voltage V.

7. The equivalent circuit for a voltage-controlled variable capacitive element according to claim 3, wherein said characteristics, to be simulated, of said voltage-controlled variable capacitive element are C-V characteristics of how gate to substrate capacitance c varies with gate to substrate voltage V.

8. The equivalent circuit for a voltage-controlled variable capacitive element according to claim 5, wherein a capacitance value of said fixed capacitor is adjusted so that values of said gate to substrate capacitance corresponding to said C-V characteristics are entirely increased.

9. The equivalent circuit for a voltage-controlled variable capacitive element according to claim 6, wherein a capacitance value of said fixed capacitor is adjusted so that values of said gate to substrate capacitance corresponding to said C-V characteristics are entirely increased.

10. The equivalent circuit for a voltage-controlled variable capacitive element according to claim 7, wherein a capacitance value of said fixed capacitor is adjusted so that values of said gate to substrate capacitance corresponding to said C-V characteristics are entirely increased.

11. The equivalent circuit for a voltage-controlled variable capacitive element according to claim 5, wherein a voltage value of said first voltage source is adjusted so that a gate to substrate voltage at which an inversion layer is created is shifted in a direction of negative voltage.

12. The equivalent circuit for a voltage-controlled variable capacitive element according to claim 6, wherein a voltage value of said first voltage source is adjusted so that a gate to substrate voltage at which an inversion layer is created is shifted in a direction of negative voltage.

13. The equivalent circuit for a voltage-controlled variable capacitive element according to claim 7, wherein a voltage value of said first voltage source is adjusted so that a gate to substrate voltage at which an inversion layer is created is shifted in a direction of negative voltage.

14. The equivalent circuit for a voltage-controlled variable capacitive element according to claim 5, wherein a voltage value of said second voltage source is adjusted so that values of said gate to substrate voltage corresponding to said C-V characteristics are entirely increased toward the side of positive potential.

15. The equivalent circuit for a voltage-controlled variable capacitive element according to claim 6, wherein a voltage value of said second voltage source is adjusted so that values of said gate to substrate voltage corresponding to said C-V characteristics are entirely increased toward the side of positive potential.

16. The equivalent circuit for a voltage-controlled variable capacitive element according to claim 7, wherein a voltage value of said second voltage source is adjusted so that values of said gate to substrate voltage corresponding to said C-V characteristics are entirely increased toward the side of positive potential.
